(19) United States
(12) Patent Application Publication
(10) Pub. No.: US 2002/0092753 A1
(43) Pub. Date: Jul. 18, 2002

(54) Pushbutton switch

(75) Inventor: Makoto Asada, Nara-shi (JP)

Correspondence Address: Russell D. Orkin, WEBB ZIESENHEIM LOGSDON ORKIN & HANSON, P.C., 700 Koppers Building, 436 Seventh Avenue, Pittsburgh, PA, 15219-1818, US

(73) Assignee: HOSIDEN CORPORATION, Osaka (JP)

(21) Appl. No.: 10/007,635

(22) Filed: Nov. 13, 2001

(30) Foreign Application Priority Data
Nov. 15, 2000 (JP) 2000-348063

(51) Int. Cl. H01H 5/18

(52) U.S. Cl. 200/406

(57) ABSTRACT

A pushbutton switch (1) includes a fixed contact portion (3) provided on a substrate (2) and an elastically deformable movable contact portion (4) provided in opposition to a surface of the fixed contact portion, the movable contact portion being configured as a dome-like portion forming a greater gap relative to the surface of the fixed contact portion at a center portion of the surface than at a peripheral portion of the surface.

The fixed contact portion (3) includes, at a center portion on the surface thereof, a surface-devoid portion (5) forming a contact edge (30) in cooperation with the surface, and the movable contact portion (4) includes a projection (6) projecting toward the surface-devoid portion of the fixed contact portion. When a press force is applied to the movable contact portion (4), the movable contact portion is elastically deformed against resilience thereof toward the contact edge (30) to come into contact with the edge or an area adjacent thereto. When the press force is released, the movable contact portion (4) is elastically restored to move its projection (6) away from the contact edge (30) or the adjacent area.

### BACKGROUND OF THE INVENTION

1. Field of the Invention

The present invention relates to a pushbutton switch, more particularly to a pushbutton switch which functions as a switch element mounted on a circuit pattern formed on a substrate.

2. Description of the Related Art

FIG. 6 shows a typical conventional pushbutton switch 10 of the above-noted type. As shown, this pushbutton switch 10 includes a lower contact 3 formed on a substrate 2 and an upper contact 4 provided as a dome-like element made of elastically deformable material and covering the lower contact 3 from the above.

The upper contact 4 is secured to the substrate 2 by means of a fixing tape 7 and is electrically connected at its outer peripheral edge to a portion of a circuit pattern insulated from the lower contact 3. When a press force is applied to the upper contact 4, the upper contact 4 is elastically deformed to bring this upper contact 4 into contact with the lower contact 3, thus establishing electric contact between the lower contact 3 and the corresponding portion of the circuit pattern. When the press force is released, the upper contact 4 is separated by its own elastic resilience from the lower contact 3, whereby the electric contact between the lower contact 3 and the corresponding portion of the circuit pattern is broken. In this manner, the assembly provides ON/OFF function as a switch element.

In the course of the above, if a foreign object 9 such as chip of the substrate generated from e.g. the substrate 2 or debris of adhesive agent generated from the fixing tape 7 is present between the upper contact 4 and the lower contact 3, this may cause imperfect contact therebetween. In order to avoid this, there has been proposed a pushbutton switch having an escape space formed at a position of the lower contact 3 opposing to the top of the upper contact, so that the escape space may allow introduction of the foreign object 9 therein so as not to interfere with the contact between the upper contact 4 and the lower contact 3. However, there is no guarantee that the foreign object will enter the escape space, i.e. a hole or recess without fail. Further, even the object once enters the space, it may move and remain out of it later.

With the conventional pushbutton switch, the upper contact has a dome-like curved face. Thus, when a press force is applied thereto for switch ON, this upper contact will be deformed convex with a significant radius of curvature toward the lower contact. This means that the point of contact between the upper and lower contacts may vary over a significant area with each switch ON operation and if the foreign object 9 is present at a particular location within the area, a contact failure occurs.

### SUMMARY OF THE INVENTION

A primary object of the invention is solve the above-described problem by providing a pushbutton switch which can reduce occurrence of contact failure due to e.g. presence of a foreign object and can operate in a highly reliable manner.

For accomplishing the object noted above, according to the present invention, a pushbutton switch comprises: a fixed contact portion provided on a substrate and an elastically deformable movable contact portion provided in opposition to a surface of the fixed contact portion, the movable contact portion being configured as a dome-like portion forming a greater gap relative to the surface of the fixed contact portion at a center portion of the surface than at a peripheral portion of the surface. The fixed contact portion includes, at a center portion on the surface thereof, a surface-devoid portion forming a contact edge in cooperation with the surface, and the movable contact portion includes a projection projecting toward the surface-devoid portion of the fixed contact portion. In operation, when a press force is applied to the movable contact portion, the movable contact portion is elastically deformed against resilience thereof toward the contact edge to come into contact with the edge or an area adjacent thereto. When the press force is released, the movable contact portion is elastically restored to move its projection away from the contact edge or the adjacent area.

With the above-described construction, at the center area of the movable contact portion configured as a dome-like portion convex away from the fixed contact portion, there is formed the projection projecting toward the surface-devoid portion formed in the fixed contact portion. Then, when a press force is applied to the movable contact portion for switch ON, the movable contact portion, especially its projection, is moved toward the fixed contact portion, especially its surface-devoid portion, and eventually the projection or its adjacent portion of the movable contact portion comes into contact with the contact edge of the fixed contact portion, thereby establishing electric connection. In this, the contact established between the movable contact portion and the fixed contact portion, that is, the contact between the projection of the former and the contact edge of the latter is realized as a line contact. Especially, the main contact point of the fixed contact portion is the contact edge, off which a foreign object if any can easily roll and fall into the hollow space of the surface-devoid portion. Thus, the possibility that such foreign object can remain still on the edge is very small, thus substantially eliminating the possibility of interference with the contact by the foreign object. Consequently, this construction assures reliable electric connection between the fixed contact and the movable contact during switch ON operation of the pushbutton switch.

According to one preferred embodiment of the invention, the surface-devoid portion and the projection are sized relative to each other in such a way as to allow at least a portion of the projection to enter the surface-devoid portion when the movable contact portion is elastically deformed. With this arrangement, during the ON operation of the pushbutton switch, the insertion of the projection into the surface-devoid portion presses the movable contact portion. Accordingly, the contact condition between the projection and the contact edge can be more secure.

Preferably, the contact edge is formed circular and the projection is configured as a circular dome or a cone having a root with a diameter greater than a diameter of the contact edge. With these, the contact therebetween is realized as a circular line contact, which provides more stable electric connection between the fixed contact portion and the movable contact portion. Further, the inclined generator line of the circular dome or cone-like projection provides the function of effectively guiding the projection into the surface-devoid portion when the center of the surface-devoid portion, i.e. the contact edge and the center of the projection are slightly out of alignment relative to each other. This inclined line or face of the projection provides another effect of pushing out and dispelling any foreign object if any.

According to a further embodiment of the present invention, the pushbutton switch includes a plurality of said projections for providing a greater number of individual contact points between the fixed contact portion and the movable contact portion. With this arrangement, required electric connection between the fixed contact portion and the movable contact portion may be assured at a certain one of the points even when contact failure occurs at another contact point due to presence of a foreign object there. In this case, advantageously, a plurality of said surface-devoid portions are provided in correspondence with the respective projections.

According to a still further embodiment, the surface-devoid portion is provided as a recess. Such recess can be easily formed by cutting away a portion of a conductive portion of the fixed contact portion which is normally constituted from the substrate and a conductive layer disposed thereon.

According to a still further embodiment, the surface-devoid portion is provided as a through hole. Such through hole can be easily provided by utilizing a through hole generally formed in the substrate to form the circuit pattern thereon.

According to a still further embodiment of the invention, the fixed contact portion is provided as a portion of the circuit pattern formed on the substrate. This arrangement simplifies the construction of the pushbutton switch and also contributes to manufacture cost reduction. In addition, a flexible sheet may be provided for covering and supporting the movable contact portion. This will further simplify the manufacture process. In this case, the process may be even more simplified if the flexible sheet is an adhesive tape. Or, by selecting a flexible sheet having an appropriate resilience, the operability of the pushbutton switch may be optimized easily.

Further and other features and advantages of the invention will become apparent upon reading the following detailed description of the preferred embodiments thereof with reference to the accompanying drawings, in which;

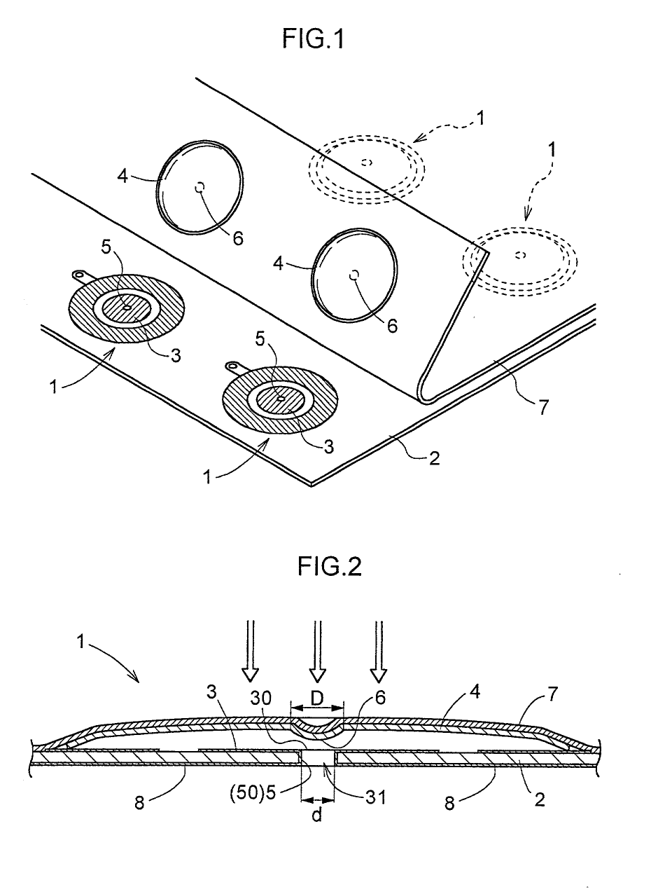

FIG. 1 is a perspective view of a pushbutton switch according to one preferred embodiment of the present invention,

FIG. 2 is a section view of the pushbutton switch,

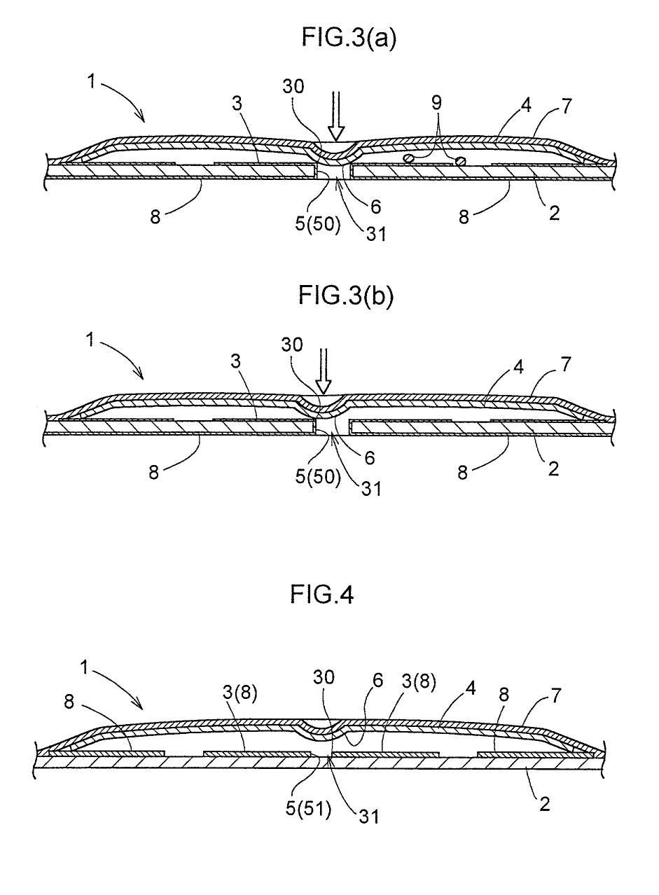

FIG. 3(a) is a section view showing a condition of the pushbutton switch when a press force is applied thereto,

FIG. 3(b) is a section view showing a further condition of the pushbutton when a press force is applied thereto when its projection and surface-devoid portion are out of alignment relative to each other,

FIG. 4 is a view showing a pushbutton switch according to another embodiment of the present invention,

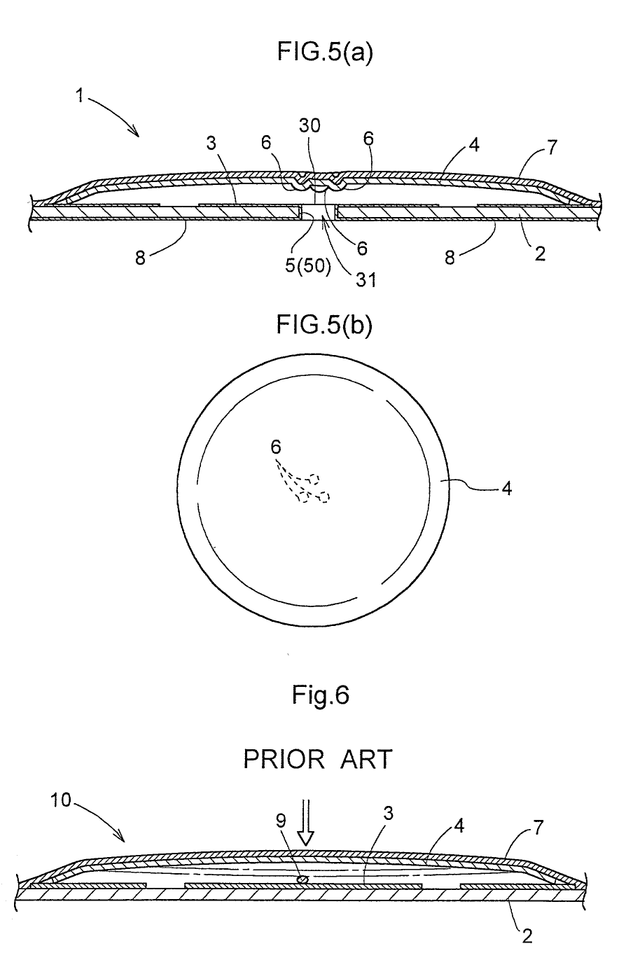

FIG. 5(a) is a view showing a pushbutton switch according to still another embodiment,

FIG. 5(b) is a plan view showing a movable contact portion of the pushbutton switch shown in FIG. 5a, and

FIG. 6 is a section view showing a conventional pushbutton switch.

### DESCRIPTION OF THE PREFERRED EMBODIMENTS

Preferred embodiments of a pushbutton switch relating to the present invention will be described in details with reference to the accompanying drawings.

A pushbutton switch 1 of the invention shown in FIGS. 1 and 2 includes a fixed contact 3 which is constituted from a substrate 2 and a portion of a circuit pattern 8 provided on the substrate 2 and a movable contact 4 formed of a thin conductive plate made of e.g. metal configured as a dome-like member covering the fixed contact 3 from above. The fixed contact 3 includes a surface-devoid portion 5 formed by a through hole 50 which is formed originally in the substrate 2. This surface-devoid portion 5 creates an inner escape hollow space 31 and a contact edge 30 along its periphery. On the other hand, the movable contact 4 includes a projection 6 which is convex downwardly, that is, convex toward the fixed contact 3. In operation, when a press force is applied to the movable contact 4, the projection 6 or its periphery of the movable contact 4 comes into contact with the contact edge 30 of the surface-devoid portion 5 of the fixed contact 3. Upon release of the press force, the movable contact 4 is restored by its own resilience to move its projection 5 away from the surface of the fixed contact 3. The escape hollow space 31 provides a function of allowing “escape” or refuge of a foreign substance therein and discharging it therefrom and another function of allowing insertion of the projection 5 during an ON operation of the pushbutton switch 1. In the instant embodiment, the projection 6 is configured as a dome or circular conical portion, whereas the surface-devoid portion 5 is formed with a circular cross section. Further, the diameter: D of the root of the dome or cone-like projection 6 is greater than the diameter of the suiface-devoid portion 5, that is, the diameter: d of the contact edge 30. With these arrangements, during the ON operation of the pushbutton switch 1, an intermediate portion of the projection 6 comes into contact with the contact edge 30. Needless to say, the diameter: D of the projection 6 root may be smaller than the diameter: d of the contact edge 30. In such case, the projection 6 and/or its adjacent periphery will come into contact with the contact edge 30 during ON operation of the pushbutton switch 1.

More particularly, in the case of the pushbutton switch 1 of the invention shown in FIGS. 1 and 2, the movable contact 4 is disposed to cover the area of the substrate forming the fixed contact 3 so that the projection 6 of the former is disposed in opposition to the surface-devoid portion 5 of the latter, and the movable contact 4 is fixed, in this condition, to the substrate 2 by means of a fixing tape 7 which is a flexible sheet. If the circuit patter 8 is formed on the opposite side of the substrate to the side of the pushbutton switch 1, then, the fixed contact 3 will be formed on this opposite side by extending the circuit patter through the thorough hole. In this case, this through hole will form the through hole 50 as the surface-devoid portion 5. Then, when this pushbutton switch 1 is pressed through the fixing tape 7 from the above with a finger, a tool or the like, the movable contact 4 will come into contact with the fixed contact 3. Upon release of the finger, tool or the like therefrom, the movable contact 4 will be restored by its own resilience back to its original position away from the fixed contact 3. In these manners, the pushbutton switch 1 is turned ON/OFF.

As shown in FIG. 3(a), as the movable contact 5 has the projection 6 projecting toward the fixed contact 3, during the press or ON operation, first the projection 6 is vertically moved toward the contact point with the fixed contact 3. Under this condition, in the area outside the contact portion, there remains a gap between the movable contact 4 and the fixed contact 3. This gap can accommodate a foreign object which may be present. More particularly, as this projection 6 has a predetermined height, a high inner “vault” is formed around the projection 6. Therefore, even if a foreign object is present between the movable contact 4 and the fixed contact 3, the clearance provided by the height of the inner vault greater than the height of the object serves to prevent the foreign object 9 from interfering with the required electric contact or connection between the movable contact 4 and the fixed contact 3.

As described above, in the case of the pushbutton switch 1 shown in FIG. 2, the projection 6 and the surface-devoid portion 5 each have a circular cross section. Then, the contact condition between the movable contact 4 and the fixed contact 3, more particularly between the projection 6 of the former and the contact edge 30 of the latter, is realized as a line contact along the circle. If the surface-devoid portion 5 is formed with a polygonal cross section such as a rectangular cross section, then, the contact between the projection 6 and the contact edge 30 will be realized as a multiple-point contact.

In the condition shown in FIG. 3(a), the center of the surface-devoid portion 6 is aligned with the center of the projection. In the actual manufacture, the switch may be assembled with the center of the movable contact 4 offset to the right or left relative to the center of the fixed contact 3. In such case, the center of the surface-devoid portion 5 will not be aligned with the center of the projection 6. However, in the case of assembly with certain degree of deviation, as shown in FIG. 3(b), the multiple-point contact condition may be maintained. Only, a certain portion of the line contact will be pressed strongly while another or other portions will be hardly pressed. Further, if the projection has an inclined lateral face, the flexibility of the movable contact 4 per se may serve to guide the projection 6 to the contact edge 30 and then into the escape hollow space 31.

Other embodiments will be described next.

FIGS. 5(a) and 5(b) show a pushbutton switch 1 having three projections 6. In this case, when the movable contact 4 is pressed, the respective projections 6 come into contact with the contact edge 30 or its peripheral area of the surface-devoid portion 5. In the case of this construction shown in FIG. 5(a), the projecting area formed by the three projections 6 is delimited to an area including the plural projections 6 denoted with dot lines and this projection area has a diameter greater than the diameter of the surface-devoid portion 5. With this, the movable contact 4 and the fixed contact 3 will come into contact at multiple points. Thus, even if a contact failure occurs at any one of the points, the contact at the other points may be maintained.

Further, though not shown, a plurality of surface-devoid portions 5 may be provided each in correspondence with each of the plurality of projections 6.

The present invention may be embodied by a skilled artisan in any other way than described above. The disclosed embodiments are provided for the purpose of illustration, not limiting the scope of the invention set forth in the appended claims.

What is claimed is:

1. A pushbutton switch comprising:
a fixed contact portion provided on a substrate, the fixed contact portion including, at a center portion on the surface thereof, a surface-devoid portion forming a contact edge in cooperation with the surface;
an elastically deformable movable contact portion provided in opposition to the surface of the fixed contact portion, the movable contact portion being configured as a dome-like portion forming a greater gap relative to the surface of the fixed contact portion at a center portion of the surface than at a peripheral portion of the surface, the movable contact portion including a projection projecting toward the surface-devoid portion of the fixed contact portion;
wherein, when a press force is applied to the movable contact portion, the movable contact portion is elastically deformed against resilience thereof toward the contact edge to come into contact with the edge or an area adjacent thereto; and when the press force is released, the movable contact portion is elastically restored to move its projection away from the contact edge or the adjacent area.

2. The pushbutton switch according to claim 1, wherein the surface-devoid portion and the projection are sized relative to each other in such a way as to allow at least a portion of the projection to enter the surface-devoid portion when the movable contact portion is elastically deformed.

3. The pushbutton switch according to claim 2, wherein the contact edge is formed circular and the projection is configured as a circular dome or a cone having a root with a diameter greater than a diameter of the contact edge.

4. The pushbutton switch according to claim 1, wherein the pushbutton switch includes a plurality of said projections.

5. The pushbutton switch according to claim 4, wherein the pushbutton switch includes a plurality of said surface-devoid portions in correspondence with the plurality of projections respectively.

6. The pushbutton switch according to claim 1, wherein the surface-devoid portion is provided as a recess.

7. The pushbutton switch according to claim 1, wherein the surface-devoid portion is provided as a through hole.

8. The pushbutton switch according to claim 1, wherein the fixed contact portion is provided as a portion of a circuit pattern formed on the substrate.

9. The pushbutton switch according to claim 1, wherein a flexible sheet is provided for covering and supporting the movable contact portion.
